(19) United States
(12) Patent Application Publication
(10) Pub. No.: US 2025/0249778 A1
(43) Pub. Date: Aug. 7, 2025

(54) ELECTRIC VEHICLE MONITORING SYSTEM

(71) Applicant: GM Global Technology Operations LLC, Detroit, MI (US)

(72) Inventors: Gopinath Menta, Canton, MI (US); Austin Lipinski, Houston, TX (US); Iqbal M. Surti, Troy, MI (US); Janak kumar Dundigalla, Sterling Heights, MI (US); Gaurav Talwar, Novi, MI (US); Thomas Doran, Shelby Township, MI (US); Frank Marotta, JR., Shorewood, WI (US)

(73) Assignee: GM Global Technology Operations LLC, Detroit, MI (US)

(21) Appl. No.: 18/434,648

(22) Filed: Feb. 6, 2024

(51) Int. Cl. B60L 53/66; B60L 53/30

(52) U.S. Cl. CPC B60L 53/66; B60L 53/305; B60L 2240/622; B60L 2240/80; B60L 2250/16

(57) ABSTRACT

An electric vehicle (EV) monitoring system for a vehicle includes a display and a server configured to receive data from one or more charging stations. The data includes a rate of charge. The EV monitoring system also includes an electronic control unit (ECU) communicatively coupled with the server and the display. The ECU includes data processing hardware that includes an EV monitoring application. The EV monitoring application includes a state of charge of the vehicle and is configured to generate a frequency diagram based on the rate of charge received by the server and the state of charge.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an electric vehicle monitoring system.

The construction of electric vehicle (EV) charging stations has lagged in comparison with sales of EVs, resulting in increased wait times for charging an EV. While current systems may assist in identifying charging stations, the wait times associated with the respective charging stations remains relatively unknown. Thus, a user may have to wait for a prolonged period of time until a charging station becomes available, which may result in unexpected delays. Further, new users of an EV may be unfamiliar with charging practices associated with prolonging the battery life of the EV. For example, many users are used to refueling an internal combustion engine (ICE) vehicle until the fuel tank reaches full, which is a different practice compared to EV charging. Thus, new and current users may experience challenges when transitioning to an EV.

### SUMMARY

In some aspects, an electric vehicle (EV) monitoring system for a vehicle includes a display of the vehicle and a server that includes geofenced zones. The server is configured to receive data from one or more charging stations within at least one of the geofenced zones, the data including a rate of charge. The EV monitoring system also includes an electronic control unit (ECU) communicatively coupled with the server and the display. The ECU includes data processing hardware that includes an EV monitoring application and a navigation application. The navigation application includes location data and a route of the vehicle. The EV monitoring application includes a state of charge of the vehicle. The EV monitoring application is configured to generate a frequency diagram based on the route from the navigation application, the rate of charge received by the server, and the state of charge.

In some examples, the EV monitoring application may be configured to display the frequency diagram on the display of the vehicle. Optionally, the data received by the server may include availability data and an average utilization. The EV monitoring application may be configured to update the generated frequency diagram based on the availability data and the average utilization. In some instances, the server may include wait time data and may be configured to calculate a delta time based on the wait time data. The EV monitoring application may be configured to update the frequency diagram based on the delta time received from the server. Optionally, the frequency diagram may include a wait time and a charge time. In some configurations, the state of charge may include a desperation factor based on a battery capacity of the vehicle and a location of the vehicle.

In other aspects, an electric vehicle (EV) monitoring system for a vehicle includes a display of the vehicle and a server configured to receive data from one or more charging stations. The data includes a rate of charge. The EV monitoring system also includes an electronic control unit (ECU) communicatively coupled with the server and the display. The ECU includes data processing hardware that includes an EV monitoring application. The EV monitoring application includes a state of charge of the vehicle and is configured to generate a frequency diagram based on the rate of charge received by the server and the state of charge.

In some examples, the EV monitoring application may be configured to display the frequency diagram on the display of the vehicle. Optionally, the data received by the server may include availability data and an average utilization. The EV monitoring application may be configured to update the generated frequency diagram based on the availability data and the average utilization. In some instances, the server may include wait time data and is configured to calculate a delta time based on the wait time data. The EV monitoring application may be configured to update the frequency diagram based on the delta time received from the server. In some configurations, the frequency diagram may include a wait time and a charge time. Optionally, the state of charge may include a desperation factor based on a battery capacity of the vehicle and a location of the vehicle.

In yet other aspects, a computer-implemented method when executed by data processing hardware causes the data processing hardware to perform operations. The operations include determining, via an electric vehicle (EV) monitoring application, a battery capacity of a vehicle, determining, via the EV monitoring application, a desperation factor based on the determined battery capacity, and identifying, based on a geofenced zone of a server, charging facilities, the charging facilities including facility data and stall data. The operations also include determining, via the server, a delta time based on the facility data and the stall data and generating, via the EV monitoring application, a frequency diagram including a wait time and a charge time.

In some examples, identifying the charging facilities may include identifying a route from an electronic control unit (ECU) of the vehicle and comparing the identified route with the geofenced zones. Optionally, the operations may include determining, by the EV monitoring application, a state of charge of the vehicle, the state of charge including the battery capacity and the desperation factor. The operations may also include displaying the generated frequency diagram on a display of the vehicle. In other instances, the operations may include preconditioning a battery of the vehicle in response to the determined state of charge and identifying the charging facility based on a preconditioning status of the battery.

A vehicle may incorporate the computer-implemented method.

### BRIEF DESCRIPTION OF THE DRAWINGS

The drawings described herein are for illustrative purposes only of selected configurations and are not intended to limit the scope of the present disclosure.

FIG. 1 is a schematic of an electric vehicle (EV) monitoring system according to the present disclosure with a vehicle equipped with an EV monitoring application and in communication with a server and a charging facility;

FIG. 2 is an example block diagram of an EV monitoring system according to the present disclosure;

FIG. 3 is another example block diagram of the EV monitoring system of FIG. 2;

FIG. 4 is a schematic of a display of a vehicle with a frequency diagram according to the present disclosure;

FIG. 5 is a schematic of a display of a vehicle with a navigation application according to the present disclosure; and

FIG. 6 is a flowchart of an example method for an EV monitoring system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

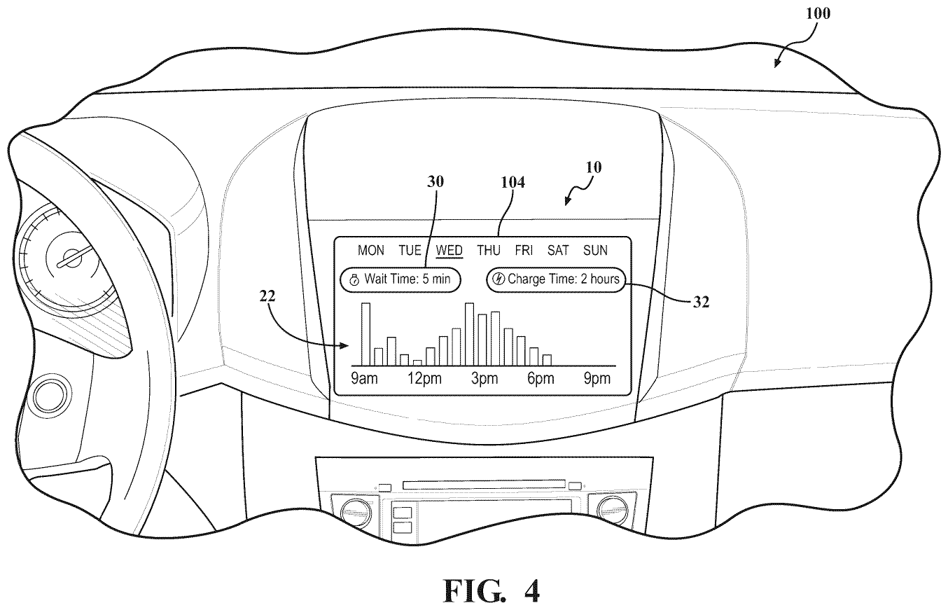

Referring now to the figures and the illustrated configurations depicted therein, a vehicle 100 communicates with a server 200 and charging facilities 300 as part of an electric vehicle (EV) monitoring system 10 described herein. The vehicle 100 is an electric vehicle (EV) including a battery 102. In other examples, the vehicle 100 may be a hybrid EV that may also be equipped with an internal combustion engine (ICE). The EV monitoring system 10 is configured to alleviate user concerns with identifying available charging facilities 300 and optimize performance of the battery 102 by executing a charge to a predetermined value, described herein. For example, the EV monitoring system 10 utilizes a network 400 to communicate data between the charging facilities 300 and the server 200 to, ultimately, present the data to the user of the vehicle 100. For example, the vehicle 100 includes a human-machine interface (HMI) or virtual control unit (VCU), which provides a touch-point between the user and the data gathered by the EV monitoring system 10. The HMI and VCU are illustrated in FIG. 4 as a display 104 of the vehicle 100.

The vehicle 100 is equipped with an electronic control unit (ECU) 12 that is configured with an EV monitoring application 14, described in more detail below. The EV monitoring application 14 is executed by data processing hardware 16 and may be stored in memory hardware 18 of the ECU 12. The EV monitoring application 14 represents the vehicle-side of the EV monitoring system 10 and utilizes the data gathered by and between the charging facilities 300 and the server 200 in combination with vehicle data, described herein. For example, the EV monitoring application 14 is configured to monitor a state of charge 20 of the vehicle 100 and to generate and display a frequency diagram 22, described herein, based on the data received from the server 200. The EV monitoring application 14 may, in some instances, monitor a battery capacity 26 of the battery 102 when determining the state of charge 20. The battery capacity 26 may be utilized, at least in part, to determine a desperation factor 28. The EV monitoring application 14 utilizes the desperation factor 28 to assist the user in determining an optimal time to execute a charge of the vehicle 100, described in more detail below. The desperation factor 28 is defined by the state of charge 20 in that the desperation factor 28 is used by the EV monitoring application 14 to determine when a user should charge the battery 102 of the vehicle 100.

The ECU 12 also includes a navigation application 40, which may be used in combination with the EV monitoring application 14. The navigation application 40 may generate a route 42 of the vehicle 100 and utilize location data 44 of the vehicle 100. The location data 44 may be determined by the navigation application 40, which may be configured as part of or separate from the ECU 12. Additionally or alternatively, the ECU 12 may be in communication with a user device such as a cellular phone or tablet that may be equipped with a global positioning system (GPS) that may be utilized in identifying location data 44 associated with the user and the vehicle 100. For example, the vehicle 100 may communicate with a user device equipped with GPS via one or more short-range wireless communication protocols, including Bluetooth®, Bluetooth® Low Energy (BLE), Wi-Fi®, low frequency (LF), and ultra-wide band (UWB).

The navigation application 40 may also include an operational status 46 of the charging facilities 300 along the route 42. For example, the charging facilities 300 may be displayed along the route 42 and, based on a respective operational status 46, may be highlighted or hidden. The operational status 46 assists the EV monitoring application 14 and, thus, the user, with identifying charging facilities 300. The operative features of the navigation application 40 in combination with the EV monitoring application 14 are described in more detail below.

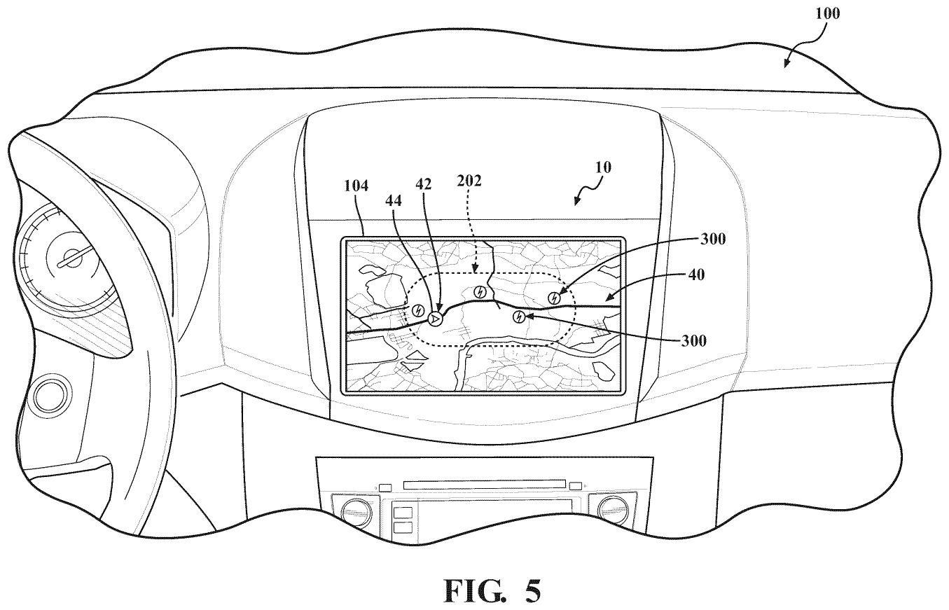

As illustrated in FIG. 5, the navigation application 40 may indicate the charging facilities 300 along the route 42 of the vehicle 100. In some instances, the navigation application 40 may display the operational status 46 of the respective charging facility 300. For example, a charging facility 300 may be present along the route 42, but may be out of service. Thus, the operational status 46 of the respective charging facility 300 may be updated on the navigation application 40 to either remove, shadow, or otherwise indicate that the charging facility 300 is out of service.

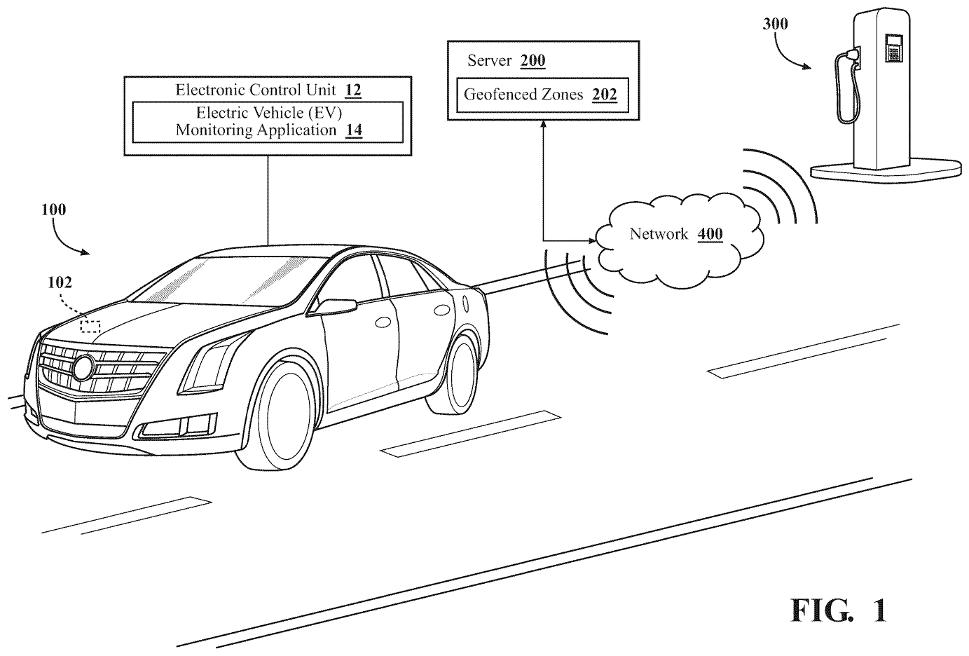

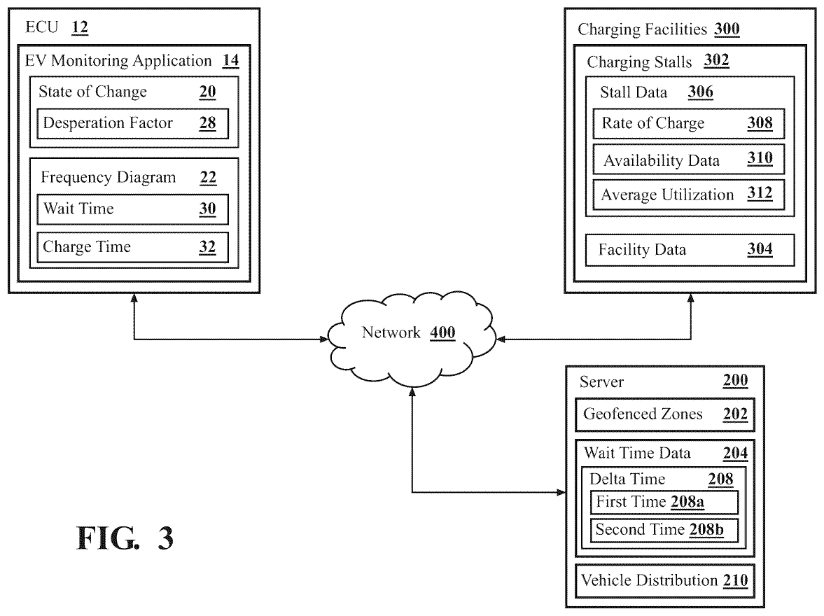

Referring to FIGS. 1-4, the server 200 is configured with geofenced zones 202 associated with various charging facilities 300. The geofenced zones 202 are defined by a radius extending from each identified charging facility 300. The server 200 stores wait time data 204 and crowdsourced data 206 associated with the geofenced zones 202 and, ultimately, shares the wait time data 204 and crowdsourced data 206 with the ECU 12. For example, the server 200 is in communication with the ECU 12 and may provide the wait time data 204 and the crowdsourced data 206 with the ECU 12 based on the geofenced zone 202 associated with the location data 44. The wait time data 204 may be collected in correlation to the charging facilities 300 within the geofenced zone 202. While the server 200 may communicate the wait time data 204 and crowdsourced data 206 with the ECU 12 when the vehicle 100 is determined to be within at least one geofenced zone 202, it is also contemplated that the ECU 12 may pull the data 204, 206 from the server 200 based on the state of charge 20. For example, the vehicle 100 may be outside of a geofenced zone 202 and may receive the wait time data 204 and the crowdsourced data 206. Thus, the state of charge 20 serves to estimate a supply and demand curve within the specified geofenced zone 202.

The server 200 includes a delta time 208 associated with a determined wait time at the respective charging facility 300. The server 200 is configured to calculate the delta time 208 based on the wait time data 204. For example, the delta time 208 is calculated based on a first time 208a associated with initiating a charge and a second time 208b associated with completion of the charge. For example, the server 200 monitors vehicles entering and exiting the geofenced zone(s) 202 to at least approximate how busy each charging facility 300 may be based on the delta time 208. The delta time 208 is also associated with a charging stall 302 of the charging facilities 300 to more precisely gather the wait time data 204. Thus, the charging stalls 302 and the same charging facility 300 may have different delta times 208 determined by the server 200. In some examples, the charging facilities 300 and the charging stalls 302 each have respective delta times 208.

The delta time 208 may be inferred by the server 200 based on the time elapsed between a vehicle GPS signal entering the geofenced zone 202 and the initiation of the charge. The server 200 aggregates the delta time 208 across all vehicles in communication with the server 200. The EV monitoring application 14 utilizes the delta time 208, in combination with the crowdsourced data 206, to generate the histogram diagram 34. Although illustrated as a histogram, the frequency diagram may be displayed as any practicable diagram to convey the wait time data 204 and the facility and/or stall data 304, 306. The EV monitoring application 14 may also utilize other vehicle data that may be received from the transmission device 50, such as a towing status, the state of charge of other vehicles, and/or the location of the charging facility, among others, to infer the charging patterns and/or behaviors. Further, the server 200 may gather similar data (e.g., the state of charge 20, charging patterns, etc.) from the EV monitoring application 14 to build a vehicle distribution 210. The EV monitoring application 14 is configured to update the frequency diagram 22 based on the delta time received from the server 200.

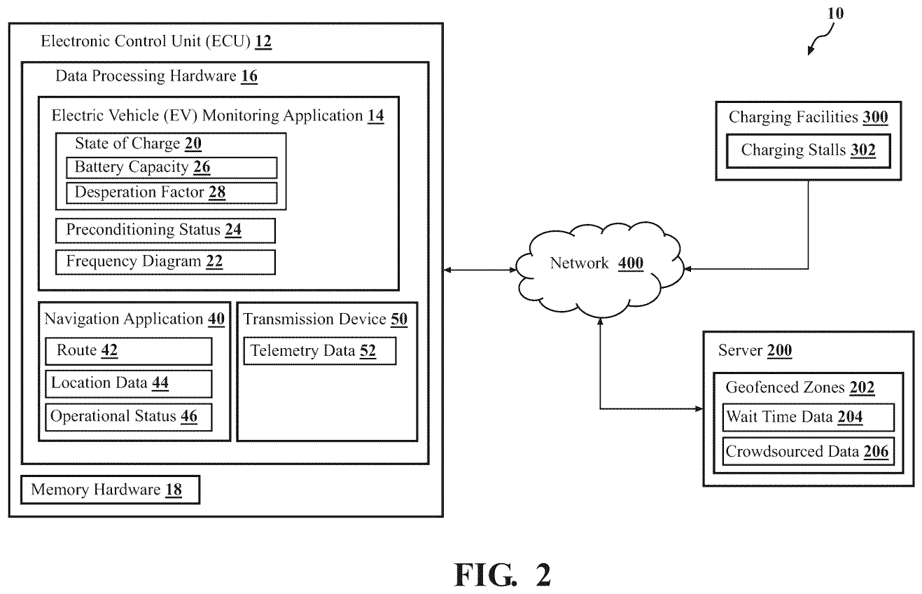

With reference now to FIGS. 2-5, the server 200 may also communicate facility data 304 and stall data 306 to the EV monitoring application 14, which may be utilized in generating the frequency diagram 22. For example, the facility data 304 may include, but is not limited to, hours of operation, number of charging stalls 302, and/or the operational status 46 associated with the respective charging facility 300. While the facility data 304 is utilized by the server 200 to identify charging facilities 300 in general, the stall data 306 further narrows the results provided to the EV monitoring application 14. The stall data 306 may include, but is not limited to, a rate of charge 308, availability data 310, and an average utilization 312 of the respective stall 302.

The stall data 306 may be collected and stored by the respective charging facility 300 and/or may be received by the server 200 as part of the crowdsourced data 206. For example, individual users may upload stall data 306 over the network 400 including the characteristics of a respective charging stall 302. In particular, the rate of charge 308 may be reported and/or gathered via the crowdsourced data 206. In some examples, users may report a first, initiation time 208a and a second, stop time 208b, which may be stored as the rate of charge 308 and used by the server 200 as crowdsourced data 206 to determine the delta time 208.

The EV monitoring application 14 receives the stall data 306 and utilizes the stall data 306 to generate and/or update the frequency diagram 22. For example, the availability data 310 provides the EV monitoring application 14 with a baseline availability of the respective charging stalls 302, while the average utilization 312 serves as refined data to inform which charging stalls 302 are most frequently used. In some examples, a charging stall 302 may be consistently available with minimal or no wait time 30 as a result of damage or other inconsistencies associated with the charging stall 302. Thus, the average utilization 312 may inform the availability data 310 to the extent that the availability data 310 alone may be incomplete. The EV monitoring application 14 may be configured to differentiate between availability and actual use based on comparison of the availability data 310 and the average utilization 312 of the respective charging stall 302. Thus, the EV monitoring application 14 may alter the provided charging stall 302 selection and/or charging facilities 300 when generating the frequency diagram 22. In some examples, the EV monitoring application 14 is configured to update the generated frequency diagram 22 based on the availability data 310 and the average utilization 312.

For example, a charging stall 302 may consistently have high availability, but the average utilization 312 may indicate that the charging stall 302 is infrequently used. The rate of charge 308 may further inform the average utilization 312 and the availability data 310. In some examples, the rate of charge 308 may indicate that the respective charging stall 302 may have a low or slow rate of charge 308. As a result, users may elect a different charging stall 302, or charging facility 300, based on the rate of charge 308 of the respective charging stall 302.

In some instances, the charging stall 302 may be labeled or otherwise categorized as a fast charge stall 302, and the rate of charge 308 may be used to verify the categorization of the charging stall 302. While the rate of charge 308 may be reported by the corresponding charging facility 300, in some instances the rate of charge 308 may be calculated by the server by calculating the delta time 208. In other instances, the rate of charge 308 may be updated or otherwise reported as part of the crowdsourced data 206. Thus, the facility data 304 and the stall data 306 collectively inform the status of the charging stalls 302 at respective charging facilities 300, which the EV monitoring application 14 may utilize in generating and updating the frequency diagram 22.

As mentioned above, the server 200 may collect crowdsourced data 206. While the crowdsourced data 206 may be pulled by the server 200, the crowdsourced data 206 may include vehicle data that is gathered by vehicles equipped with the EV monitoring application 14 as part of the EV monitoring system 10. Thus, the crowdsourced data 206 may be passively gathered by the EV monitoring system 10 to, ultimately, assist in refining the frequency diagram 22. The crowdsourced data 206 may be gathered from software defined vehicles (SDV) that are connected with the server 200. For example, the SDV may be connected with the server 200 via the network 400.

The crowdsourced data 206 may be utilized to aggregate the wait time data 204. The aggregated wait time data 204 is presented on the frequency diagram 22 as the wait time 30 and as the histogram diagram 34. The histogram diagram 34 represents how busy the charging facilities 300 and/or the optimal charging stall may be at a given time-of-day. In the instances that the charging facility 300 has multiple optimal charging stalls 302, the histogram diagram 34 may display how busy the charging facility 300, in general, is at a given time-of-day. In some examples, the vehicle 100 may directly receive the wait time data 204 from a nearby vehicle. For example, a nearby vehicle may broadcast the wait time data 204 to the vehicle 100 using vehicle-to-vehicle methods. Thus, the wait time data 204 represents accurate, real-time information.

The EV monitoring application 14 utilizes the wait time data 204, in combination with the facility data 304 and the stall data 306, to calculate busy times across the known charging facilities 300. For example, the EV monitoring application 14 may utilize a transmission device 50, such as an OnStar® system that includes operative functions including, but not limited to, in-vehicle security, emergency services, turn-by-turn navigation, and remote diagnostics. The transmission device 50 may be configured to communicate telemetry data 52 from the vehicle 100 and may receive telemetry data 52 from other vehicles configured with the transmission device 50. The telemetry data 52 may contain the facility data 304 and/or the stall data 306, such that the EV monitoring application 14 may calculate the wait time 30 and/or the charge time 32 from the telemetry data 52.

Referring still to FIGS. 2-5, the frequency diagram 22 includes wait time 30 and charge time 32, each of which may be informed by the stall data 306 and the wait time data 204 from the server 200. The frequency diagram 22 may display the wait time 30 and the charge time 32 for a respective charging stall 302 and/or charging facility 300. For example, the EV monitoring application 14 may identify a charging facility 300 and subsequently identify a charging stall 302 based on the stall data 306. In some examples, the EV monitoring application 14 may use the charging stall 302 with the shortest wait time 30 as the displayed frequency diagram 22. In other instances, the EV monitoring application 14 may select the charging stall 302 with the fastest charge time 32. In further examples, the EV monitoring application 14 may present options to the user, to allow the user to elect the charging facility 300 and/or charging stall 302 based on the respective wait time 30 and charge time 32.

The EV monitoring application 14 is configured to display the frequency diagram 22 on the display 104 of the vehicle 100. The frequency diagram 22 is presented to the user on the display 104 as a histogram diagram 34 (FIG. 4) indicating peak times of day that the respective charging facility 300 is active. The frequency diagram 22 may be updated for specific times of day and may be adjusted to show a larger or smaller range of times of day depending on the user's preferences. Further, the user may select a day of the week to see the frequency diagram 22 for a different day of the week. The frequency diagram 22 is configured to automatically adjust to present the current day and a relative range of times of day.

As noted above, the frequency diagram 22 may be repeatedly updated based on the wait time data 204. For example, the server 200 may continuously determine the delta time 208 for a respective charging stall 302, and the EV monitoring application 14 may update the frequency diagram 22 based on the delta time 208 received from the server 200. The frequency diagram 22 may be presented on the display 104 in response to the state of charge 20. For example, the EV monitoring application 14 may identify that the battery capacity 26 of the vehicle 100 is at a level that would benefit from receiving a charge.

For example, the EV monitoring application 14 may be configured to recommend a charge when the battery capacity 26 drops below approximately twenty-percent (20%). Thus, the EV monitoring application 14 is continuously monitoring to ensure sufficient charge between charging facilities 300. The EV monitoring application 14 may also consider the preconditioning status 24, which accounts for the temperature of the battery before executing the charge. Thus, the preconditioning status 24 may be utilized by the EV monitoring application 14 when identifying the nearest charging facility 300. Further, the EV monitoring application 14 may recommend a stop time for the charge. For example, the EV monitoring application 14 may recommend charging the battery 102 to a predetermined amount or percentage. In some non-limiting examples, the EV monitoring application 14 may recommend charging the battery 102 to approximately eighty-percent (80%).

In some instances, the EV monitoring application 14 may recommend a charge based on the desperation factor 28. The desperation factor 28 may be based on, at least in part, the battery capacity 26. For example, the battery capacity 26 may be at approximately thirty-percent (30%), and the EV monitoring application 14 may determine a time range within which the user should charge the vehicle 100. The EV monitoring system 10 may utilize the recommended time range to identify charging facilities 300 within range. If no charging facilities 300 are identified toward the end of the time range, then the EV monitoring application 14 may adjust the desperation factor 28. For example, while the desperation factor 28 may be determined based on the current battery capacity 26 of the vehicle 100, the desperation factor 28 may also be determined based on the location data 44 of the vehicle 100 relative to the charging facilities 300. The desperation factor 28 may also have a sliding scale of urgency dependent on the state of charge 20. For example, a state of charge 20 corresponding to approximately twenty-one-percent (21%) may have a lower desperation factor 28 as compared to a state of charge 20 corresponding to approximately five-percent (5%).

In some examples, the EV monitoring application 14 may determine that the battery capacity 26 is sufficient to continue for a determined distance. However, the facility data 304 may indicate that the charging facilities 300 may be spaced apart, such that a distance between charging facilities 300 is outside of the determined distance. Thus, the EV monitoring application 14 may increase the desperation factor 28 based on the location of the respective charging facilities 300 and recommend charging the vehicle 100. In some examples, the desperation factor 28 is determined based on the battery capacity 26 and the location of the vehicle 100, which is determined based on the location data 44. The increased desperation factor 28 may prompt the frequency diagram 22 to be displayed on the display 104 and encourage the user to stop and charge the vehicle 100. The user may utilize the frequency diagram 22 to identify a charging facility 300 that has the shortest wait time 30 and the fastest charge time 32 and may further identify the same for a respective charging stall 302 at the selected charging facility 300.

In some examples, the EV monitoring application 14 may utilize the preconditioning status 24 to determine when the battery 102 is at a temperature that is configured to maximize the charge capabilities. The EV monitoring application 14 may communicate the preconditioning status 24 with the navigation application 40 to optimize the route 42 while minimizing potential damage to the battery 102. For example, the EV monitoring application 14 may apply a cost function that utilizes the state of charge 20, including a temperature of the preconditioning status 24, the wait time data 204, the charge time 32, and the facility and/or stall data 304, 306. Thus, the crowdsourced data 206 may be utilized with the state of charge 20 to determine or at least inform the route 42, in some examples. Utilizing the preconditioning status 24 and determining the route 42 accordingly assists in preserving a health of the battery 102. The recommended charging habits (e.g., charging to a predetermined percentage and/or upon reaching a predetermined percentage) may further maximize the overall battery life and health of the battery 102 by minimizing strain on the battery capacity 26.

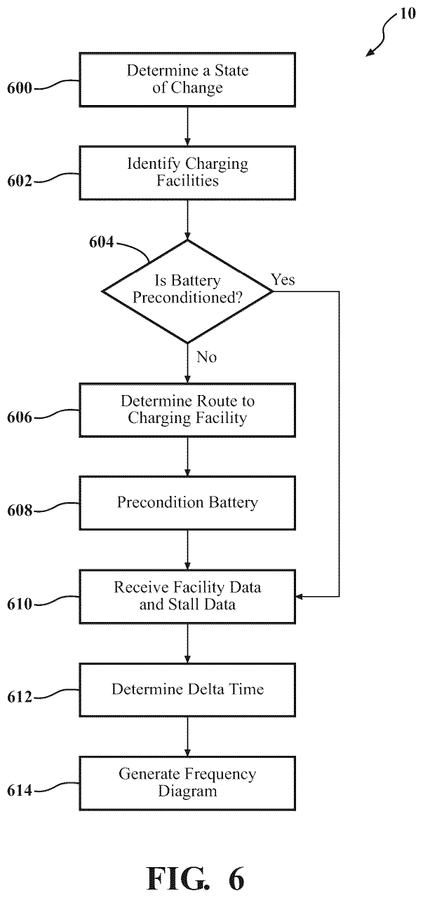

Referring to FIG. 6, an example flow diagram for the EV monitoring system 10 is illustrated. The EV monitoring system 10 may first determine, at 600, the state of charge 20 of the vehicle 100. For example, the EV monitoring system 10, via the EV monitoring application 14, may determine the battery capacity 28 of the vehicle 100 and the desperation factor 28 based on the determined battery capacity 26. The EV monitoring application may then identify, at 602, charging facilities 300. For example, the EV monitoring system 10, via the server 200, may identify charging facilities 300 based on the geofenced zones 202. Further, the EV monitoring system 10 may identify the charging facilities 300 based on the preconditioning status 24 of the battery 102.

The EV monitoring system 10, via the EV monitoring application 14, may then determine, at 604, the preconditioning status 24 of the battery 102. If the battery 102 is not preconditioned, then the EV monitoring system 10 determines, at 606, a route 42 to a charging facility 300 and preconditions the battery 102, at 608, along the determined route 42. In some examples, the EV monitoring system 10 may identify a route 42 from the ECU 12 and may compare the identified route 42 with the geofenced zones 202 when identifying the charging facilities 300. The EV monitoring system 10 may execute the EV monitoring application 14 to precondition the battery 102 in response to the preconditioning status 24 and the state of charge 20. The EV monitoring system 10 receives, at 610, the facility data 304 and the stall data 306. If the battery 102 is preconditioned, then the EV monitoring system 10 automatically executes step 610.

Depending on the facility data 304 and the stall data 306 received, the EV monitoring system 10 may identify a different charging facility 300. At 612, the EV monitoring system 10 determines the delta time 208. For example, the EV monitoring system 10, via the server 200, determines the delta time 208 based on the facility data 304 and the stall data 306. Based on the delta time 208, the facility data 304, and the stall data 306, the EV monitoring system 10 generates, at 614, the frequency diagram 22 via the EV monitoring application 14. The frequency diagram 22 is displayed on the display 104 of the vehicle 100.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An electric vehicle (EV) monitoring system for a vehicle, the EV monitoring system comprising:
a display;
a server including geofenced zones and being configured to receive data from one or more charging stations within at least one of the geofenced zones, the data including a rate of charge; and
an electronic control unit (ECU) communicatively coupled with the server and the display, the ECU including data processing hardware including an EV monitoring application and a navigation application, the navigation application including location data and a route of the vehicle, the EV monitoring application including a state of charge of the vehicle and being configured to generate a frequency diagram based on the route from the navigation application, the rate of charge received by the server, and the state of charge.

2. The EV monitoring system of claim 1, wherein the EV monitoring application is configured to display the frequency diagram on the display of the vehicle.

3. The EV monitoring system of claim 1, wherein the data received by the server includes availability data and an average utilization, the EV monitoring application being configured to update the generated frequency diagram based on the availability data and the average utilization.

4. The EV monitoring system of claim 1, wherein the server includes wait time data and is configured to calculate a delta time based on the wait time data.

5. The EV monitoring system of claim 4, wherein the EV monitoring application is configured to update the frequency diagram based on the delta time received from the server.

6. The EV monitoring system of claim 1, wherein the frequency diagram includes a wait time and a charge time.

7. The EV monitoring system of claim 1, wherein the state of charge includes a desperation factor based on a battery capacity of the vehicle and a location of the vehicle.

8. An electric vehicle (EV) monitoring system for a vehicle, the EV monitoring system comprising:
a display;
a server configured to receive data from one or more charging stations, the data including a rate of charge; and
an electronic control unit (ECU) communicatively coupled with the server and the display, the ECU including data processing hardware including an EV monitoring application, the EV monitoring application including a state of charge of the vehicle and being configured to generate a frequency diagram based on the rate of charge received by the server and the state of charge.

9. The EV monitoring system of claim 8, wherein the EV monitoring application is configured to display the frequency diagram on the display of the vehicle.

10. The EV monitoring system of claim 8, wherein the data received by the server includes availability data and an average utilization, the EV monitoring application being configured to update the generated frequency diagram based on the availability data and the average utilization.

11. The EV monitoring system of claim 8, wherein the server includes wait time data and is configured to calculate a delta time based on the wait time data.

12. The EV monitoring system of claim 11, wherein the EV monitoring application is configured to update the frequency diagram based on the delta time received from the server.

13. The EV monitoring system of claim 8, wherein the frequency diagram includes a wait time and a charge time.

14. The EV monitoring system of claim 8, wherein the state of charge includes a desperation factor based on a battery capacity of the vehicle and a location of the vehicle.

15. A computer-implemented method when executed by data processing hardware causes the data processing hardware to perform operations comprising:
determining, via an electric vehicle (EV) monitoring application, a battery capacity of a vehicle;
determining, via the EV monitoring application, a desperation factor based on the determined battery capacity;
identifying, based on a geofenced zone of a server, charging facilities, the charging facilities including facility data and stall data;
determining, via the server, a delta time based on the facility data and the stall data; and
generating, via the EV monitoring application, a frequency diagram including a wait time and a charge time.

16. The method of claim 15, wherein identifying the charging facilities includes identifying a route from an electronic control unit (ECU) of the vehicle and comparing the identified route with the geofenced zones.

17. The method of claim 15, further including determining, by the EV monitoring application, a state of charge of the vehicle, the state of charge including the battery capacity and the desperation factor.

18. The method of claim 15, further including displaying the generated frequency diagram on a display of the vehicle.

19. The method of claim 15, further including preconditioning a battery of the vehicle in response to the determined state of charge and identifying the charging facility based on a preconditioning status of the battery.

20. A vehicle incorporating the method of claim 15.
